(19) United States
(12) Patent Application Publication
(10) Pub. No.: US 2009/0073508 A1
(43) Pub. Date: Mar. 19, 2009

(54) IMAGE FORMING APPARATUS

(75) Inventor: Tetsuya Sadowara, Mishima-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,767

(22) Filed: Sep. 10, 2008

Related U.S. Application Data
(60) Provisional application No. 60/972,471, filed on Sep. 14, 2007.

(51) Int. Cl. H04N 1/04

(52) U.S. Cl. 358/474

(57) ABSTRACT

A scanner scans an image of an original document as first image data. A first image processor processes the first image data scanned by the scanner. The first image processor stores the processed first image data to a memory in a state of compressed code data. A second image processor reads the first image data stored in the memory as the code data. The second image processor process the first image data read from the memory for printing. An image synthesizer synthesizes pixel data of the second image data with respective pixel data of the first image data after the image processing for printing by the calculation processing. A printer prints the synthesized image data.

### CROSS-REFERENCE TO RELATED APPLICATIONS

This application claims the benefit of U.S. Provisional Application No. 60/972,471, filed Sep. 14, 2007.

### TECHNICAL FIELD

The present invention relates to an image forming apparatus such as a digital multifunctional peripheral having an image synthesizing function for synthesizing a plurality of image data.

### BACKGROUND

In the related art, some of image forming apparatuses such as a digital multifunctional peripheral has an image synthesizing function for synthesizing a plurality of images. For example, the digital multifunctional peripheral has a function to add information indicating the date or information indicating the page number on images to be printed as the image synthesizing function. General digital multifunctional peripheral stores image data in a memory in a state of a compressed code data. A complicated calculation is required in order to synthesize two images stored in the memory in the state of the code data. Therefore, the image synthesizing function mounted on the current digital multifunctional peripheral is intended only for a simple image synthesizing process in many cases. For example, the image synthesizing function mounted on the current digital multifunctional peripheral is substitution of simple data, or image synthesis at a low resolution. When the image synthesis is performed by the substitution of data, there is a problem that the original image data is completely deleted. In addition, synthetic image data obtained by synthesizing a design image such as a background pattern may be subjected to deterioration of the design image such as the background pattern due to an image processing such as a tone processing after the synthesizing process. In such a case, there arises a problem that a user is not able to obtain synthetic image data having an intended design image synthesized thereto as the printed result with the digital multifunctional peripheral.

### SUMMARY

An image forming apparatus as the aspect of the invention includes: a memory that stores code data; an expander that expands the code data stored in the memory; a synthesizer that synthesizes second image data with first image data obtained by expanding the code data by the expander; and an image forming unit that forms the image data synthesized by the synthesizer on an image formed medium.

A copying apparatus as an aspect of the invention includes: a scanner that scans an image on an original document; a compressor that compresses image data scanned by the scanner; a memory that stores code data obtained by compressing the image data by the compressor; an expander that expands the code data stored in the memory; a synthesizer that synthesizes second image data with first image data obtained by expanding the code data by the expander; and an image forming unit that forms image data synthesized by the synthesizer on an image formed medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration example of an image forming apparatus according to a first embodiment;

FIG. 2 is a timing chart for explaining a signal processing in an image synthesizer in the image forming apparatus according to the first embodiment;

FIG. 3 is a drawing for explaining signals that the image synthesizer of the image forming apparatus enters and outputs according to the first embodiment;

FIG. 4 is a block diagram showing a configuration example of the image forming apparatus according to a second embodiment; and

FIG. 5 is drawing for explaining signals that the image synthesizer of the image forming apparatus enters and outputs according to the second embodiment.

### DETAILED DESCRIPTION

Referring now to the drawings, embodiments will be described.

First of all, a first embodiment will be described.

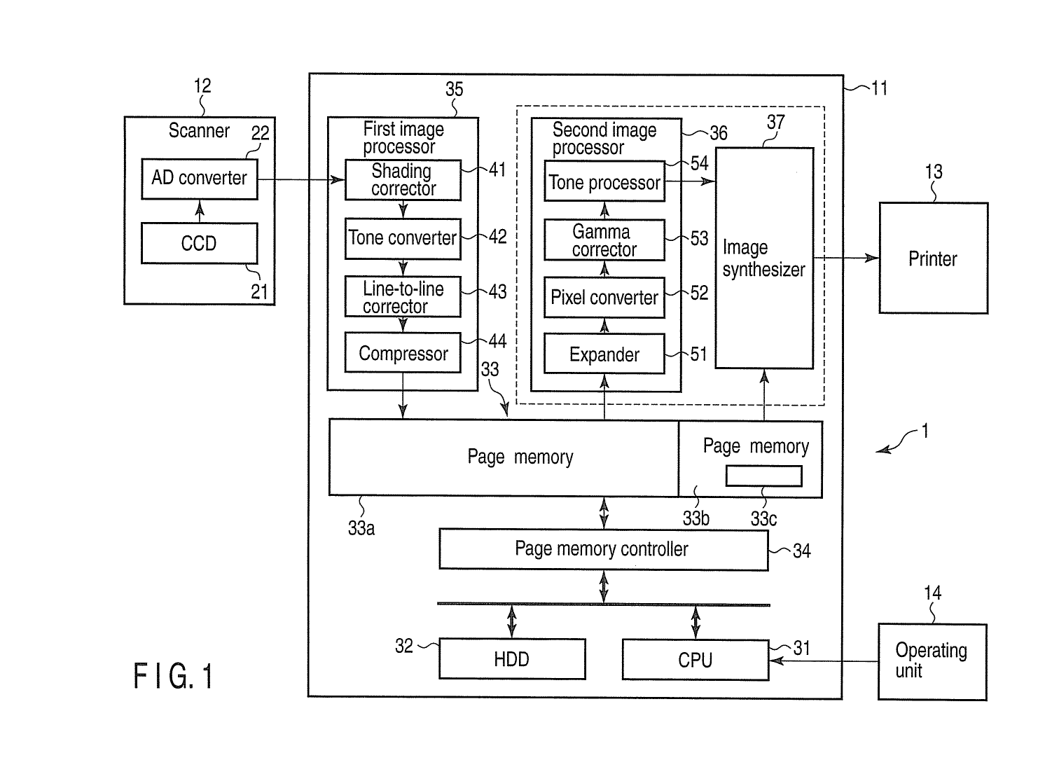

FIG. 1 is a block diagram showing a configuration example of an image forming apparatus 1 according to a first embodiment.

As shown in FIG. 1, the image forming apparatus 1 includes a main control unit 11, a scanner 12, a printer 13, and an operating unit 14. The image forming apparatus 1 is, for example, a digital copying machine or a digital multifunctional peripheral.

The main control unit 11 controls the entire image forming apparatus 1. For example, the main control unit 11 controls the operation of the scanner 12 or the printer 13. The main control unit 11 includes a function to process an image and a function to save the image.

The scanner 12 optically scans the image on a recording medium. The scanner 12 converts the image on the recording medium into image data. The scanner 12 supplies scanned image data to the main control unit 11. The scanner 12 includes a CCD 21 and an AD converter 22. In other words, in the scanner 12, the CCD 21 converts reflected light from the recording medium into an analogue image signal. The AD converter 22 converts the analogue image signal scanned by the CCD 21 into a digital image signal. The printer 13 forms the image data supplied from the main control unit 11 on an image formed medium. A printer having a given image forming system is also applicable as the printer 13. For example, the printer 13 may be a laser printer, or may be an inkjet printer. The operating unit 14 includes a display device and an operating key. For example, the operating unit 14 includes a liquid crystal display device having a touch panel built therein and a hard key such as a ten-key.

The main control unit 11 includes a CPU 31, an HDD 32, a page memory 33, a page memory controller 34, a first image processor 35, a second image processor 36, and an image synthesizer 37. The CPU 31 controls the entire image forming apparatus. The CPU 31 implements various functions by executing programs stored in a memory, not shown. For example, the CPU 31 implements a copy control by controlling the scanner 12 and the printer 13 according to a program for copy control. The HDD (hard disk drive) 32 is a non-volatile memory. The HDD 32 saves the image data. For example, the HDD 32 stores code data as the compressed image data.

The page memory 33 is a memory for storing images to be processed. The page memory controller 34 controls the page memory 33. For example, image data for one page is stored in the page memory 33. In the configuration example in FIG. 1, the page memory 33 includes a first area 33a and a second area 33b. The first area 33a stores first image data. The first image data is, for example, image data taken from the scanner 12, or image data to be outputted to the printer 13. The second area 33b stores second image data. The second image data is image data to be synthesized with the first image data.

The second area 33b of the page memory 33 may be adapted to store image data composed of pixel data including pixels each having a binary value (either “1” or “0”) as the second image data. In this case, the page memory 33 is provided with a register 33c. The register 33c may be provided in a memory other than the page memory 33. The register 33c stores a density value (resister value) of effective pixels (pixels whose pixel data is “1”) in the second image data. The register 33c is able to update values to be stored (register values) as needed. For example, the register values in the register 33c are updated as needed by the operating unit 14 on the basis of values entered by an operator.

The first image processor 35 processes the image data taken from the scanner 12. The first image processor 35 includes, for example, a shading corrector 41, a tone converter 42, a line-to-line corrector 43, and a compressor 44.

The shading corrector 41 corrects the shading of the image data scanned by the scanner 12. The shading correction is a process for correcting image data according to fluctuations in sensitivity among photoelectric conversion elements in the CCD 21 or light distribution characteristics of a lamp (not shown) for illuminating an original document.

The tone converter 42 converts the tone of the image data which is corrected in shading by the shading corrector 41. The tone conversion is a process for converting the values of the respective pixels which constitute the image data (for example, signal values of R, G, and B) according to a lookup table (LUT), not shown. For example, a 10-bit value in the entered image data is converted into an 8-bit value in the tone conversion.

The line-to-line corrector 43 corrects the line-to-line distance on the tone-converted image data which is converted in tone by the tone converter 42. The line-to-line correction is a process which corrects a physical positional displacement of respective sensors of RGB in the CCD21. The line-to-line correction corrects the positional displacement among the lines in the image data.

The compressor 44 compresses the image data in which the line-to-line distance is corrected by the line-to-line corrector 43. The page memory 33 stores the code data as the image data compressed by the compressor 44 in the first area 33a.

The second image processor 36 processes the image data to be outputted to the printer 13. In other words, the second image processor 36 performs an image processing which generates image data for printing. The second image processor 36 includes, for example, an expander 51, a pixel converter 52, a gamma corrector 53, and a tone processor 54.

The expander 51 expands the code data (compressed image data) stored in the page memory 33. In other words, the expander 51 converts the code data on the page memory 33 into non-compressed image data.

The pixel converter 52 converts density of the image and filters the same. The pixel converter 52 converts the density of the image data expanded by the expander 51. Here, when the image data expanded by the expander 51 is a color image composed of R (red), G (green), and B (blue) signals, the pixel converter 52 converts the image data into image data composed of C (cyan), M (magenta), Y (yellow), and K signals. In general, the scanner 12 scans the image of the original document as color image data composed of the R, G, and B signals in many cases. In general, the printer 13 prints the color image data composed of the C, M, Y, and K signals in many cases. The pixel converter 52 filters the image data which is converted in density. The filtering is, for example, MTF correction.

The gamma corrector 53 performs a gamma correction on the image data. The gamma correction is a process for correcting the image data according to gamma characteristics of the printer 13. The tone processor 54 performs a screen treatment on the image data which is gamma-corrected by the gamma corrector 53. The tone processor 54 outputs the screen-treated image data to the image synthesizer 37. However, when the image synthesis by the image synthesizer 37 is not performed, the tone processor 54 outputs the screen-treated image data to the printer 13 as the image data for printing.

The image synthesizer 37 synthesizes a plurality of image data. The image synthesizer 37 synthesizes an image data to another image data. The image synthesizer 37 here is assumed to synthesize the first image data and the second image data processed by the second image processor 36. For example, the image synthesizer 37 synthesizes the data or the page number as the second image data with the first image data. The image synthesizer 37 may be adapted to synthesize a design image such as a background pattern as the second image data with the first image data. Furthermore, the image synthesizer 37 may be adapted to synthesize watermark image data as the second image with the first image data.

A flow of processing in the image forming apparatus 1 will be schematically described.

The scanner 12 optically scans the image data of the original document, not shown, according to the instruction given from the CPU 31 of the main control unit 11 to start scanning. The scanner 12 supplies the read image data to the main control unit 11. In the main control unit 11, the first image processor 35 performs the processes such as the shading correction, the tone conversion, the line-to-line correction, and the compression with respect to the image data scanned by the scanner 12. The page memory 33 stores the code data in the first area 33a as the image data compressed by the first image processor 35. The page memory 33 also includes the second area 33b that stores the second image data to be synthesized with the first image data stored in the first area 33a. The CPU 31 saves the code data stored in the page memory 33 in the HDD 32 as needed.

When printing the code data saved in the HDD 32, the CPU 31 reads the corresponding code data from the HDD 32 to the page memory 33. The second image processor 36 performs the processes such as the expansion, the filtering, the gamma-correction, and the tone processing on the code data read out into the page memory 33. The data processed by the second image processor 36 is expanded first image data for printing (for example, the color image data composed of the respective signals of Y, M, C, and K). When synthesizing another second image data with such the first image data, the image synthesizer 37 synthesizes the second image data stored in the second area 33b on the page memory 33 with respect to the first image data for printing. In this case, the image synthesizer 37 outputs the synthesized image data to the printer 13. When the image synthesis is not performed, the main control unit 11 outputs the image data processed by the second image processor 36 to the printer 13 as the image data for printing. The printer 13 prints the image data for printing supplied from the main control unit 11 on a printing sheet.

Subsequently, an example of processing performed in the image synthesizer 37 will be described in detail.

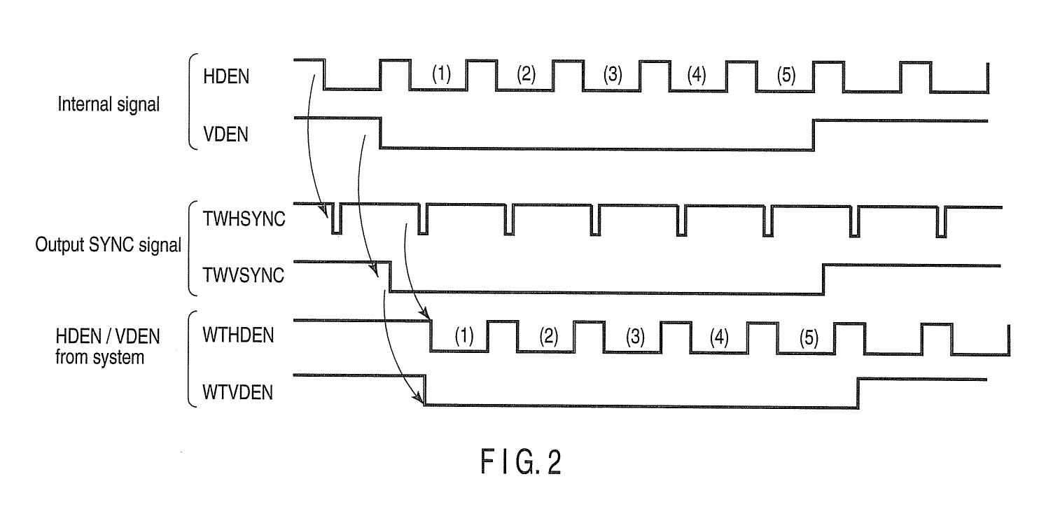

FIG. 2 is a timing chart for explaining a signal processing performed in the image synthesizer 37.

The image synthesizer 37 enters the first image data processed by the second image processor 36 and the second image data stored in the second area 33b of the page memory 33. The image synthesizer 37 enters the first image data according to an effective signal in the primary scanning direction (HDEN) and an effective signal in the secondary scanning direction (VDEN) as shown in FIG. 2. The effective signal in the primary scanning direction (HDEN) is a signal which indicates an effective period of the primary scanning direction on the image data. The effective signal in the secondary scanning direction (VDEN) is a signal which indicates the effective period of the secondary scanning direction on the image data. For example, the image synthesizer 37 enters pixel data of respective pixels which constitute the first image data in sequence at timing when the HDEN and the VDEN both become “L”.

The image synthesizer 37 outputs a synchronous signal in the primary scanning direction (TWHSYNC) to the page memory controller 34 at timing when the HDEN is changed from “H” to “L”. The image synthesizer 37 outputs a synchronous signal in the secondary scanning direction (TWVSYNC) to the page memory controller 34 at timing when the VDEN is changed from “H” to “L”. The TWHSYNC and the TWVSYNC are signals which indicate timings synchronous with the HDEN and the VDEN.

Therefore, the page memory controller 34 is able to output signals to the image synthesizer 37 synchronously with the HDEN and the VDEN by the TWHSYNC and the TWVSYNC. For example, the page memory controller 34 outputs an effective signal in the primary scanning direction (WTHDEN) and an effective signal in the secondary scanning direction (WTVDEN) for supplying the second imaged data to the image synthesizer 37 according to the TWHSYNC and the TWVSYNC from the image synthesizer 37. In other words, the effective signal in the primary scanning direction (WTHDEN) and the effective signal in the secondary scanning direction (WTVDEN) indicate timings that the image synthesizer 37 synthesizes the image (calculation processing described later).

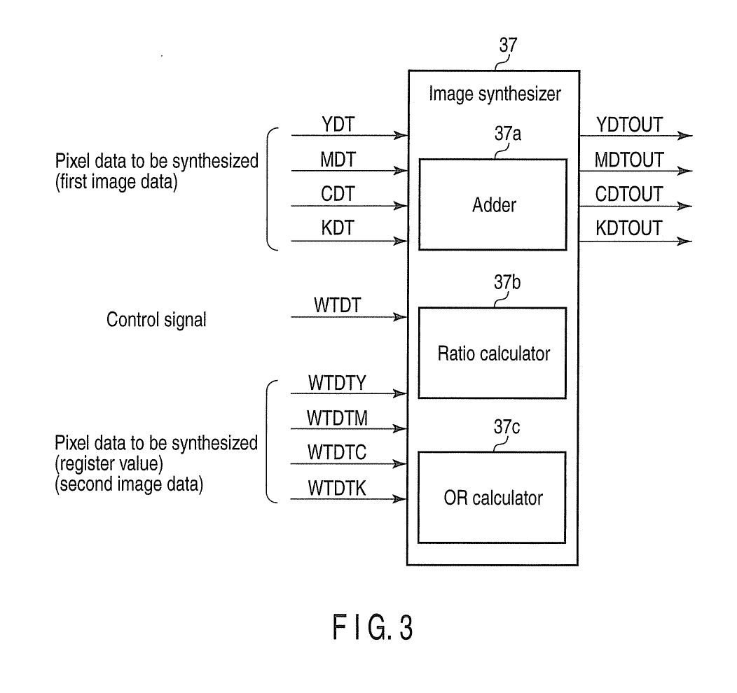

FIG. 3 is a drawing for explaining signals to be entered and outputted by the image synthesizer 37.

In an example shown in FIG. 3, the image synthesizer 37 enters pixel data (YDT, MDT, CDT, and KDT) of the first image data, pixel data (WTDTY, WTDTM, WTDTC, and WTDTK) of the second image data, and a control signal (WTDT). The image synthesizer 37 outputs pixel data (YDTOUT, MDTOUT, CDTOUT, and KDTOUT) of the synthetic image data. Here, it is assumed that the binary image data is stored in the second area 33b of the page memory 33 as the second image data, and the density values (register values) of the effective pixels in the second image data are stored in the register 33c.

The page memory controller 34 supplies the control signal (WTDT) to the image synthesizer 37. The control signal (WTDT) is one of “0” and “1” as one-bit signal. Therefore, the page memory controller 34 outputs “1” or “0” as the control signal (WTDT) depending on whether the respective pixels in the second image data are effective pixels (pixel value “1”) or not. In other words, the page memory controller 34 outputs “1” as the control signal (WTDT) indicating that “image to be synthesized” is present when the pixels to be outputted as the second image data are effective data (having the pixel value “1”).

When the control signal (WTDT) is “1”, the image synthesizer 37 calculates the pixel data (YDT, MDT, CDT, and KDT) of the first image data and density values (WTDTY, WTDTM, WTDTC, and WTDTK) stored in the register 33c. This calculation is a process for synthesizing the pixel data of the second image data with the pixel data on the first image data. In the example shown in FIG. 3, the image synthesizer 37 selectively performs any one of an addition, a ratio calculation, and an OR calculation as a method of calculation. In the configuration example shown in FIG. 3, the image synthesizer 37 includes an adder 37a, a ratio calculator 37b, and an OR calculator 37c. In other words, the image synthesizer 37 selects any one of the adder 37a, the ratio calculator 37b, or the OR calculator 37c as a processor for performing the calculation processing.

For example, when generating a synthetic image by simply adding the pixel data of the first image data and the pixel data of the second image data, the image synthesizer 37 selects the calculation processing by the adder 37a. The adder 37a outputs the pixel data (YDTOUT, MDTOUT, CDTOUT, KETOUT) obtained by adding the pixel data (YDT, MDT, CDT, and KDT) of the first image data and the density values (WTDTY, WTDTM, WTDTC, and WTDTK) stored in the resistor 33c as the pixel data of the synthetic image when the control signal (WTDT) is “1”.

In other words, when the WTDT is “1”, the adder 37a calculates as follows.

YDTOUT=YDT+WTDTY (clip to 255 when it exceeds 255),

MDTOUT=MDT+WTDTM (clip to 255 when it exceeds 255),

CDTOUT=CDT+WTDTC (clip to 255 when it exceeds 255),

KDTOUT=KDT+WTDTK (clip to 255 when it exceeds 255),

The adder 37a may be adapted not to perform an adding operation when the value of YDT+MDT+CDT+KDT is a certain value or higher. For example, when the printer 13 is a laser printer using a toner, a toner limit may be controlled by the process as described above. Consequently, a problem of defective fixation due to too much overlapping of toner is prevented.

When synthesizing the pixel data of the first image data and the pixel data of the second image data at a ratio α, the image synthesizer 37 selects the calculation processing by the ratio calculator 37b. However, the ratio α is assumed to be a value which satisfies 0≦α≦1. When the control signal (WTDT) is “1”, the ratio calculator 37b outputs the pixel data (YDTOUT, MDTOUT, CDTOUT, and KDTOUT) obtained by synthesizing the pixel data (YDT, MDT, CDT, and KDT) of the first image data and the density values (WTDTY, WTDTM, WTDTC, and WTDTK) stored in the register 33c at the ratio α as the pixel data of the synthetic image.

In other words, when the WTDT is “1”, the ratio calculator 37b calculates as follows;

YDTOUT=YDT+α X(WTDTY−YDT)

MDTOUT=MDT+α X(WTDTM−MDT)

CDTOUT=CDT+α X(WTDTC−CDT)

KDTOUT=KDT+α X(WTDTK−KDT).

When synthesizing the pixel data of the first image data and the pixel data of the second image data by the OR calculation, the image synthesizer 37 selects the calculation processing by the OR calculator 37c. When the control signal (WTDT) is “1”, the OR calculator 37c performs the OR calculation on the pixel data (YDT, MDT, CDT, and KDT) of the first image data and the density values (WTDTY, WTDTM, WTDTC, and WTDTK) stored in the resistor 33c for each bit. The image synthesizer 37 outputs the pixel data (YDTOUT, MDTOUT, CDTOUT, and KDTOUT) obtained by the OR calculator 37c as the pixel data of the synthetic image.

In other words, when the WTDT is “1”, the OR calculator 37c calculates as follows.

YDTOUT=YDT∪WTDTY,

MDTOUT=MDT∪WTDTM,

CDTOUT=CDT∪WTDTC,

KDTOUT=KDT∪WTDTK.

Subsequently, the register values stored in the register 33c will be described.

The register values stored in the register 33c are pixel data as the second image data to be synthesized with the first image data. For example, when the first image data is a color image, the each pixel of the color image data for printing which is already processed by the second image processor 36 has the respective density values of Y, M, C, and K. In this case, synthetic colors having the respective density values of Y, M, C, and K are set as the register values. The register values as described above may be set according to an operating type of the image forming apparatus. For example, the register values may be fixed values set as default values. The register values may be values specified by a user by the operating unit 14. In this case, an operating type in which the user enters the density values of the respective colors directly by the operating unit 14 is applicable. However, an operating type in which a plurality of color candidates are displayed as candidates of the register values on the display unit of the operating unit 14, so that the user specifies a color from these candidates is also applicable. An operating type in which the user specifies the density of the color (shade or light) as the register value by the operating unit 14 is also applicable.

The register value or the ratio α may be set according to the characteristics of the printer 13. For example, in the configuration example in FIG. 1, the gamma corrector in the second image processor performs the gamma correction on the first image data. However, the second image data to be synthesized, that is, the gamma correction is not taken into consideration for the register value. Therefore, it is considered that the synthetic image having the register value synthesized therewith might become image data suitable for being printed by the printer 13 by setting the register value taking the gamma correction corresponding to the printer 13 into consideration. In other words, the same effect as performing the gamma correction on the second image data is achieved by setting the register value taking the gamma correction into consideration.

The register values taking the gamma correction into consideration may be calculated by the CPU 31. For example, it is assumed that a conversion table 32a according to the characteristics of the gamma correction corresponding to the printer 13 is saved in the HDD 32. Such the conversion table 32a reads, for example, patches of Y, M, C, and K so that obtained information indicating the characteristics of the gamma correction (correction curve) corresponding to the printer 13 is stored therein. The CPU 31 converts set values specified by the user into register value taking the gamma correction into consideration according to the conversion table 32a. In this case, the register 33c stores the register value taking the gamma correction into consideration. The CPU 31 is also able to set the ratio α to a value corresponding to the characteristics (a value taking the gamma correction into consideration) of the printer 13 in the same manner as the resister value.

As described above, the image forming apparatus 1 described in the first embodiment does not synthesize the images on the page memory, but synthesizes the second image data with the first image data after the image processing for printing is performed. Therefore, with the image forming apparatus 1, the image quality is not deteriorated much due to the image processing after image synthesis. The image forming apparatus 1 does not substitute the data on the page memory, but synthesizes the first image data after the image processing and the second image data by calculation processing in the image synthesizer. Therefore, the image forming apparatus 1 is able to synthesize a watermark as well.

In addition, in the image forming apparatus 1, it is assumed that the respective pixels in the second image data are expressed by one-bit. The respective pixel data of the second image data expressed by one-bit is data which represents effectiveness or ineffectiveness of the image processing. When the pixel data of the second image data is effective, the image synthesizer synthesizes the register value stored in the register (for example, the pixel data composed of the density values of the respective colors) with the pixel data of the first image data. In this case, since the respective pixels in the second image data are expressed by one-bit, the memory capacity for storing the second image data in the image forming apparatus 1 is saved. In addition, the image forming apparatus 1 does not perform unnecessary calculation for the pixels which do not need to be synthesized, so that high-speed processing with less deterioration of image quality is achieved.

In the image synthesizer in the image forming apparatus 1, a set value taking the gamma correction corresponding to the printer into consideration (the register value or the ratio α used in the ratio calculation) is set. The image forming apparatus 1 is able to perform an adequate gamma correction not only to the first image data, but also to the second image data. The image forming apparatus 1 synthesizes the images at an adequate density value without causing an unnatural difference in density between the first image data and the second image data.

Subsequently, a second embodiment will be described.

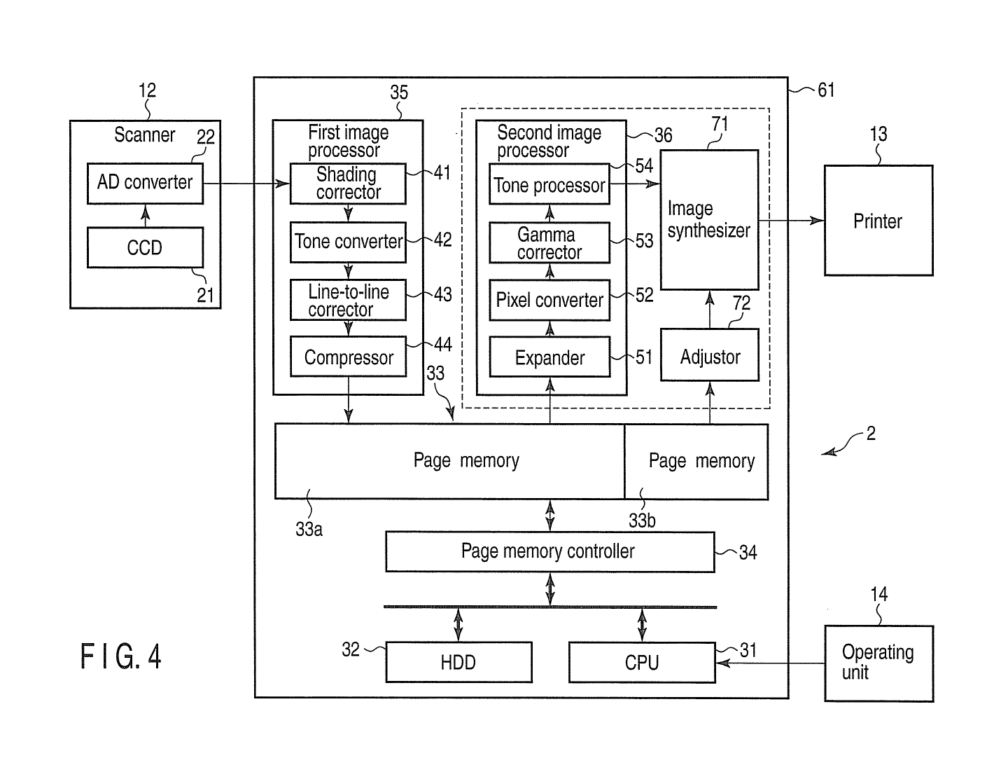

FIG. 4 is a block diagram showing a configuration example of an image forming apparatus 2 according to the second embodiment.

The image forming apparatus 2 shown in FIG. 4 is, for example, a digital copying machine or a digital multifunctional peripheral. As shown in FIG. 4, the image forming apparatus 2 is a modification of the image forming apparatus 1 shown in FIG. 1 described in the first embodiment. The image forming apparatus 2 shown in FIG. 4 includes a main control unit 61, the scanner 12, the printer 13, and operating unit 14. The scanner 12, the printer 13, and the operating unit 14 may be those having the similar configuration to those described in the first embodiment. Therefore, detailed description of the scanner 12, the printer 13, and the operating unit 14 will be omitted.

The main control unit 61 controls the entire image forming apparatus 2. For example, the main control unit 61 controls the operation of the scanner 12 or the printer 13 in the same manner as the main control unit 11 shown in FIG. 1. The main control unit 61 includes the CPU 31, the HDD 32, the page memory 33, the page memory controller 34, the first image processor 35, the second image processor 36, an image synthesizer 71, and an adjustor 72. In other words, the main control unit 61 shown in FIG. 4 includes the adjustor 72 in addition to the configuration of the main control unit 11 shown in FIG. 1. The image synthesizer 71 is connected to the second image processor 36 and the adjustor 72. Since the respective configurations other than the image synthesizer 71 and the adjustor 72 shown in FIG. 4 are similar to the respective components shown in FIG. 1, detailed description will be omitted.

In the image forming apparatus 2, the second image data is adjusted (processed) by the adjustor 72 before being synthesized with the first image data. In the image forming apparatus 2, it is assumed that the second image data stored in the second area 33b of the page memory 33 is not image data composed of binary pixels, but image data composed of multi-level pixels. In other words, the second area 33b in the page memory 33 of the image forming apparatus 2 according to the second embodiment stores the second image data composed of a plurality of pixels which might become various pixel data.

The adjustor 72 adjusts the pixel data of the second image data. The adjustor 72 is an image processor for the second image data. For example, the adjustor 72 is able to perform an image processing equivalent to the image processing in the second image processor 36. In other words, the adjustor 72 performs the pixel conversion, the filtering, the gamma correction, or the tone correction. In the tone correction in the adjustor 72, the color or the sharpness is adjusted. The adjustor 72 also has a function to adjust the color or the sharpness in the second image data according to a value of adjustment that the user enters by the operating unit 14. The adjustor 72 supplies the adjusted second image data to the image synthesizer 71.

In other words, in the image forming apparatus 2 shown in FIG. 4, the first image data processed by the second image processor 36 and the second image data processed by the adjustor 72 are supplied to the image synthesizer 71. The image synthesizer 71 synthesizes the pixel data of the first image data supplied from the second image processor 36 and the pixel data of the second image data supplied from the adjustor 72 synchronously.

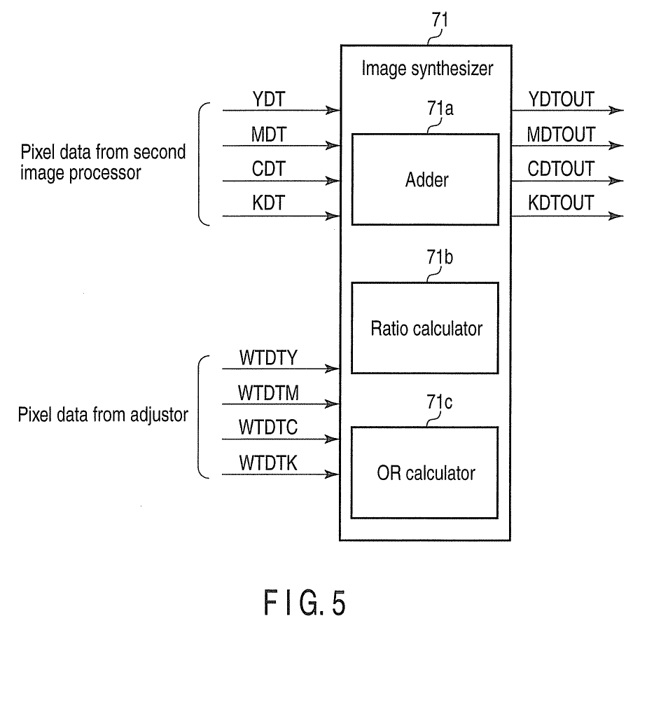

FIG. 5 is a drawing for explaining signals entered and outputted by the image synthesizer 71.

In the example shown in FIG. 5, the image synthesizer 71 enters the pixel data (YDT, MDT, CDT, and KDT) of the first image data and the pixel data (WTDTY, WTDTM, WTDTC, and WTDTK) of the second image data. The image synthesizer 71 outputs the pixel data (YDTOUT, MDTOUT, CDTOUT, and KDTOUT) of the synthetic image data. Here, it is assumed that the image data composed of the multi-level pixel data as the second image data is stored in the second area 33b of the page memory 33.

The image synthesizer 71 performs the calculation processing on the pixel data of the first image data and the pixel data of the second image data supplied synchronously. The second image processor 36 and the adjustor 72 are adjusted in delay time so as to synchronously output the pixel data respectively. In other words, the pixel data of the first image data read from the first area 33a and the pixel data of the second image data read from the second area 33b are adjusted in delay time in the second image processor 36 and the adjustor 72 so as to be synchronously supplied to the image synthesizer 71.

The calculation processing in the image synthesizer 71 may be a processing similar to that in the first embodiment. In other words, in the example shown in FIG. 5, the image synthesizer 71 selectively performs one of the addition, the ratio calculation, and the OR calculation as the method of calculation. TH image synthesizer 71 shown in FIG. 5 also includes an adder 71a, a ratio calculator 71b, and an OR calculator 71c in the same manner as the image synthesizer 37 shown in FIG. 3. The adder 71a, the ratio calculator 71b and the OR calculator 71c are processors which perform the same calculation processing as the adder 37a, the ratio calculator 37b, or the OR calculator 37c.

As described above, the image forming apparatus 2 in the second embodiment synthesizes the respective image data after image processing by processing to the both image data to be synthesized. Since the image forming apparatus 2 synthesizes the respective image data after the image processing, deterioration of the image quality due to the image processing on the synthetic image data after image synthesis is avoided. The image forming apparatus 2 is able to process both the two image data to be synthesized, respectively. In addition, the image forming apparatus 2 allows the user to specify the value of adjustment for the image quality with respect to the image data to be synthesized.

Additional advantages and modifications will readily occur to these skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a memory that stores code data;
an expander that expands the code data stored in the memory;
a synthesizer that synthesizes second image data with first image data obtained by expanding the code data by the expander; and
an image forming unit that forms image data synthesized by the synthesizer on an image formed medium.

2. The apparatus according to claim 1, further comprising a filtering unit that filters the first image data expanded by the expander,
wherein the synthesizer synthesizes the second image data with the first image data filtered by the filtering unit.

3. The apparatus according to claim 1, further comprising a gamma corrector that performs gamma correction on the first image data expanded by the expander,
wherein the synthesizer synthesizes the second image data with the first image data after the gamma correction is performed thereon by the gamma corrector.

4. The apparatus according to claim 1, further comprising a tone processor that processes a tone of the first image data expanded by the expander,
wherein the synthesizer synthesizes the second image data with the first image data after a tone processing is performed thereon by the tone processor.

5. The apparatus according to claim 1, wherein the synthesizer calculates pixel data of the first image data and pixel data of the second image data supplied synchronously.

6. The apparatus according to claim 5, wherein the synthesizer performs any one of an addition, a ratio calculation, or an OR calculation as the calculation.

7. The apparatus according to claim 5, further comprising a register that stores pixel data of effective pixels in the second image data,
wherein the synthesizer calculates the pixel data of the first image data and the pixel data of the effective pixels in the second image data stored in the register supplied synchronously.

8. The apparatus according to claim 7, further comprising:
an operating unit that enters the pixel data of the effective pixels in the second image data; and
an updater that updates a value stored in the register into the pixel data entered in the operating unit.

9. The apparatus according to claim 7, further comprising:
an operating unit that enters the pixel data of the effective pixels in the second image data; and
an updater that updates a value stored in the register into a value obtained by converting the pixel data entered into the operating unit by characteristics of a gamma correction in the image forming unit.

10. The apparatus according to claim 1, further comprising an adjustor that adjusts the second image data,
wherein the synthesizer synthesizes the second image data adjusted by the adjuster with the first image data expanded by the expander.

11. The apparatus according to claim 10, further comprising an operating unit that enters a value of adjustment,
wherein the adjustor adjusts the second image data with the value of adjustment entered to the operating unit.

12. The apparatus according to claim 10, wherein the adjustor adjusts a color of the second image data.

13. The apparatus according to claim 10, wherein the adjustor adjusts the sharpness of the second image data.

14. The apparatus according to claim 10, wherein the adjustor supplies pixel data of the adjusted second image data and pixel data of an area to be synthesized in the first image data expanded by the expander synchronously to the synthesizer, and
the synthesizer calculates the pixel data of the first image data and the pixel data of the second image data supplied synchronously.

15. The apparatus according to claim 14, wherein the synthesizer performs any one of an addition, a ratio calculation and an OR calculation as the calculation.

16. A copying apparatus comprising:
a scanner that scans an image on an original document;
a compressor that compresses image data scanned by the scanner;
a memory that stores code data obtained by compressing the image data by the compressor;
an expander that expands the code data stored in the memory;
a synthesizer that synthesizes a second image data with a first image data obtained by expanding the code data by the expander; and
an image forming unit that forms image data synthesized by the synthesizer on an image formed medium.

17. The apparatus according to claim 16, further comprising a register that stores pixel data of effective pixels in the second image data,
wherein the synthesizer calculates the pixel data of the first image data and density values of the effective pixels in the second image data stored in the register supplied synchronously.

18. The apparatus according to claim 17, further comprising:
an operating unit that enters the pixel data of the effective pixels in the second image data; and
an updater that updates a value stored in the register into pixel data entered to the operating unit.

19. The apparatus according to claim 16, further comprising an adjustor that adjusts the second image data,
wherein the synthesizer synthesizes the second image data adjusted by the adjustor with the first image data expanded by the expander.

20. The apparatus according to claim 19, further comprising an operating unit that enters a value of adjustment,
wherein the adjustor adjusts the second image data with the value of adjustment entered to the operating unit.
